(19) United States
(12) Patent Application Publication
(10) Pub. No.: US 2018/0140030 A1
(43) Pub. Date: May 24, 2018

(54) CLOSURES

(71) Applicant: Ipsum Limited, Gateshead (GB)

(72) Inventor: Rowena Dilys PLANT, Gateshead (GB)

(21) Appl. No.: 15/569,800

(22) PCT Filed: Apr. 25, 2016
(86) PCT No.: PCT/GB2016/051158

§ 371 Date: Oct. 27, 2017

(30) Foreign Application Priority Data
Apr. 27, 2015 (GB) 1507080.8
Jul. 13, 2015 (GB) 1512235.1

(51) Int. Cl. A41F 1/00; H01F 1/055; H01F 1/057; H01F 1/08; H01F 1/117; H01F 41/16; H01F 7/02

(52) U.S. Cl. CPC A41F 1/002; H01F 1/0558; H01F 1/0578; H01F 7/0263; H01F 1/117; H01F 41/16; H01F 1/083

(57) ABSTRACT

Disclosed is a method of magnetising a substrate comprising the steps of: preparing a magnetising coat by dispersing a plurality of particles of at least one magnetisable material in a binder; applying the magnetising coat on a surface of the substrate;

setting the magnetising coat; and magnetising the magnetisable material in the magnetising coat by exposing the magnetising coat to a magnetic field.

### TECHNICAL FIELD OF THE INVENTION

The present invention concerns the provision of a method of magnetising a substrate, a method of forming a magnetic closure, or a magnetic closure. Embodiments of the invention find particular, but not exclusive, use in fabric fastening.

### BACKGROUND TO THE INVENTION

A conventional way of manufacturing a magnetic closure for use with a fabric comprises mechanically attaching a pair of magnets onto two separate portions of the fabric so that the magnetic field therebetween can be used for magnetically attaching two surfaces of the fabric together. Having to mechanically attach such magnets is cumbersome and the presence of the magnets, with different mechanical strength and/or density, on the fabric can often lead to tearing of the fabric and/or detachment of the magnet itself during washing or repeated handling.

In order to address such disadvantages, attempts have been made to introduce the magnetic property into the fabric itself. A suggested way of manufacturing such magnetic fabric involves producing a textile fibre with magnetic properties, and then forming the woven and/or nonwoven fabric therefrom using known techniques such as weaving and/or hydroentanglement respectively. The textile fibres are made magnetic by coating the textile fibres with magnetic metals or alloys.

WO2007/001898 discloses disposable articles which may have magnetic members incorporated into the fibres of the articles so as to facilitate applying and removing the articles to and from the body of an individual.

However, since the coating of the textile fibre takes place before forming the fabric, any techniques used for forming the fabric and treating the fabric thereafter must ensure that they do not affect the magnetic properties and/or damage the magnetic components of the textile fibres. For example, the techniques involving waterproof/anti-mosquito coating, dyeing, laser cutting, and/or stitching should be applied with due care to the magnetic properties and/or magnetic components of the textile fibres in mind. This restricts design freedom of the fabric as well as leading to potentially larger manufacturing costs.

It is an aim of embodiments of the present invention to overcome one or more problems associated with the prior art and to provide a method of magnetising a substrate, forming a magnetic closure, or a magnetic closure.

### SUMMARY OF THE INVENTION

According to the present invention there is provided a method and apparatus as set forth in the appended claims. Other features of the invention will be apparent from the dependent claims, and the description which follows.

In accordance with a first aspect of the present invention, there is provided a method of magnetising a substantially planar substrate comprising the steps of:

(a) preparing a magnetisable coating by dispersing a plurality of particles of at least one magnetisable material in a binder, where the particles have a diameter of up to 20 μm;

(b) applying the magnetisable coating on a surface of the substrate; and

(c) magnetising the magnetisable coating by exposing it to a magnetic field.

It will be apparent to the skilled addressee that the concentration of particles in the magnetisable coating, specific size, shape and aspect ratio of the particles, as well as the size and shape distribution and the magnetizing method (including temperature and voltage), will vary and depend upon the specific magnetising magnetic closure being produced and the properties of a given magnetisable coating will be optimised so as to ensure uniform distribution throughout the binder. It is desirable that the particle size will be greater than the superparamagnetic limit for the specific material, concentration and magnetisation method employed.

Preferably, the particles have a diameter in the range of 0.08 to 20 μm. More preferably, the particles have a diameter in the range of 0.1 to 15 μm. Even more preferably, the particles have a diameter in the range of 0.25 to 10 μm. Yet more preferably, the particles in the magnetisable coating have a diameter in the range of 0.5 to 5 μm. Even yet more preferable, the particles in the magnetisable coating have a diameter in the range of 1 to 5 μm. Most preferably, the particles in the magnetisable coating have a diameter in the range of 2.5 to 5 μm. In the alternative, the particles have a diameter of up to about 15 μm. Even more preferably, the particles have a diameter of up to about 10 μm. Most preferably, the particles have a diameter of up to about 5 μm.

In accordance with a further related aspect of the present invention, there is provided a method of magnetising a substantially planar substrate comprising the steps of:
(a) preparing a magnetisable coating by dispersing a plurality of particles of at least one magnetisable material in a binder, where the particle size is greater than the superparamagnetic limit of the magnetisable material;
(b) applying the magnetisable coating on a surface of the substrate; and
(c) magnetising the magnetisable coating by exposing it to a magnetic field.

The process may further comprise setting the magnetisable coating after it has been applied on the surface of the substrate.

The magnetisable coating may be applied by droplet deposition and/or film deposition.

Droplet deposition may comprise spaying the magnetisable coating onto the surface at a predetermined pressure.

Film deposition may comprise: placing the substrate on a bed; introducing the magnetisable coating on to a coating rod for generating a continuous film; and introducing the magnetisable coat onto the surface of the substrate by engaging the coating rod onto the surface.

The film deposition technique may comprise: urging the magnetisable coating on to a surface of the substrate by passing the substrate and magnetisable coating through calender rollers under a predetermined pressure. The magnetisable coating may be applied to the surface of the substrate before or during its passage through the calender rollers. It is preferred that the magnetisable coating is poured on to at least one or more of the calendar rollers before the substrate passed therebetween. Although the magnetisable coating may be co-extruded or extruded onto the substrate prior to being passed between the calendar rollers.

The magnetisable coating may additionally comprise a drying and/or curing step(s). Such drying or curing steps will be dependent upon the coating used and will be well understood by the skilled addressee.

Magnetising the magnetisable material may comprises a number of methods. However, it is preferred that the substrate is placed near an electromagnet and/or a superconducting magnet.

The magnetisable material may comprise the localised magnetising of the magnetisable material on only a portion of the surface using a capacitive discharge or pulse magnetiser.

The method may further comprise the step of demagnetising the magnetisable material before magnetising the magnetisable material.

In accordance with a further aspect, there is provided a method of forming a magnetic closure comprising a first surface and a second surface, the method comprising the steps of:

magnetising a first substrate whereon the first surface is located using the method of magnetising a substrate as defined herein above; and

preparing the second surface by providing at least one of paramagnetic material or diamagnetic material thereon, and/or by magnetising a second substrate whereon the second surface is located using the method of magnetising a substrate as defined herein above,

wherein the second surface is arranged to engage the first surface using a magnetic field from the magnetised first or second substrate,

whereby the magnetic closure closes and/or remains closed when the first and second surfaces are brought in close or adjacent proximity with one another.

The first substrate and the second substrate may be located on different portions of the same substrate and/or are formed in a unitary manner.

The method of claim may further comprising the steps of: providing a first topographical structure on the first surface; and/or providing a second topographical structure on the second surface, wherein the first and second structures are arranged to be mechanically engagable with one another, whereby predetermined portions of the first surface and the second surface are mechanically engagable in addition to being magnetically attracted to one another.

The first and/or second topographical structures may comprise at least one selected from: ridges, channels, protrusions, and/or recesses.

The method may further comprise a step of patterning the magnetising coating, or patterning the magnetism, on the first and/or second surface to form the first and/or second structures.

In accordance with a yet further aspect of the present invention, there is provided a magnetic closure comprising a first surface and a second surface, wherein:

a first substantially planar substrate, whereon the first surface is located, is magnetised by a magnetising a magnetisable coating comprising a plurality of particles of at least one magnetisable material in a binder applied on the first surface;

the second substantially planar surface is providing with at least one of paramagnetic material or diamagnetic material thereon, and/or a second substrate, whereon the second surface is located, is magnetised by a magnetising a magnetisable coating comprising a plurality of particles of at least one magnetisable material in a binder applied on the second surface; and

the second surface being arranged to engage the first surface using a magnetic field from the magnetised first or second substrate,

where the particles in the magnetisable coating have a diameter of up to 20 μm and whereby the magnetic closure closes and/or remains closed when the first and second surfaces are brought in close or adjacent proximity with one another.

Preferably, the particles have a diameter in the range of 0.08 to 20 μm. More preferably, the particles have a diameter in the range of 0.1 to 15 μm. Even more preferably, the particles have a diameter in the range of 0.25 to 10 μm. Yet more preferably, the particles in the magnetisable coating may have a diameter in the range of 0.5 to 5 μm. Even yet more preferably, the particles in the magnetisable coating have a diameter in the range of 1 to 5 μm. Most preferably, the particles in the magnetisable coating have a diameter in the range of 2.5 to 5 μm. In the alternative, the particles preferably have a diameter of up to about 15 μm. Even more preferably, the particles have a diameter of up to about 10 μm. Most preferably, the particles have a diameter of up to about 5 μm.

In accordance with yet a further related aspect of the present invention, there is provided a magnetic closure comprising a first surface and a second surface, wherein:

a first substantially planar substrate, whereon the first surface is located, is magnetised by a magnetising a magnetisable coating comprising a plurality of particles of at least one magnetisable material in a binder applied on the first surface;

the second substantially planar surface is providing with at least one of paramagnetic material or diamagnetic material thereon, and/or a second substrate, whereon the second surface is located, is magnetised by a magnetising a magnetisable coating comprising a plurality of particles of at least one magnetisable material in a binder applied on the second surface; and

the second surface being arranged to engage the first surface using a magnetic field from the magnetised first or second substrate,

where the particles in the magnetisable coating have a particle size which is greater than the superparamagnetic limit of the magnetisable material and whereby the magnetic closure closes and/or remains closed when the first and second surfaces are brought in close or adjacent proximity with one another.

The first substrate and the second substrate may be located on different portions of the same substrate and/or are formed in a unitary manner.

The magnetic closure may comprise: a first topographical structure is provided on the first surface; a second topographical structure is provided on the second surface; and

the first and second structures are arranged to be mechanically engagable with one another, whereby predetermined portions of the first surface and the second surface are mechanically engagable in addition to being magnetically attracted to one.

The first and/or second topographical structures may comprise at least one selected from: ridges, channels, protrusions, and/or recesses.

The second surface may be provided with magnetisable material which is magnetised in the same orientation to the magnetisable material of the first surface so that the first and second surfaces experience an attractive force from the magnetic field therebetween.

The second surface may be provided with magnetisable material which is magnetised in an opposite orientation to the magnetisable material of the first surface so that the first and second surfaces experience a repulsive force from the magnetic field therebetween.

The magnetisable material may comprise a ferromagnetic or ferrimagnetic material.

The magnetisable material may preferably comprises at least one of Magnetite, Neodymium Iron Boron, Samarium Cobalt, or Alnico.

The binder may be a film-forming polymer. Preferably, such a polymer will a water based emulsion binder.

The substrate may comprise a fabric, but could potentially be any material to which a magnetic closure is required.

The substrate may be a nonwoven fabric, such as a polypropylene spunbond fabric.

### DETAILED DESCRIPTION OF THE INVENTION

For a better understanding of the invention, and to show how embodiments of the same may be carried into effect, reference will now be made, by way of example, to the accompanying diagrammatic drawings in which:

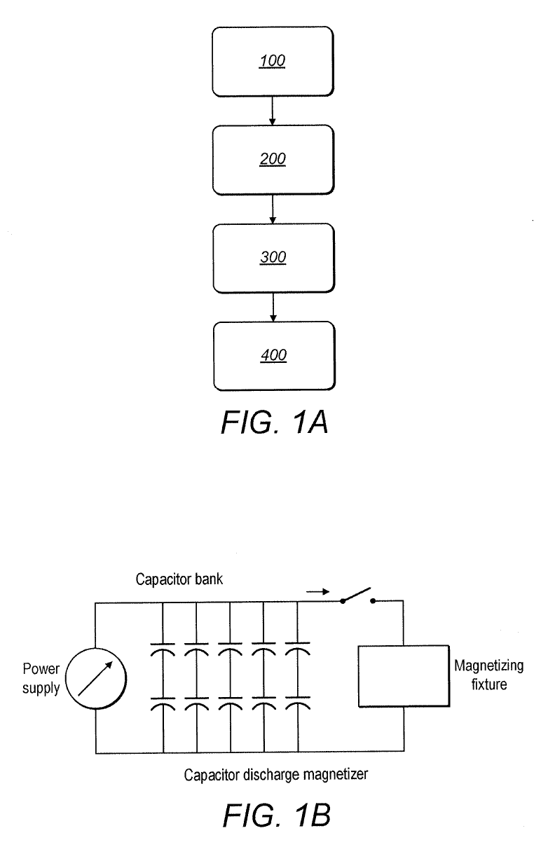

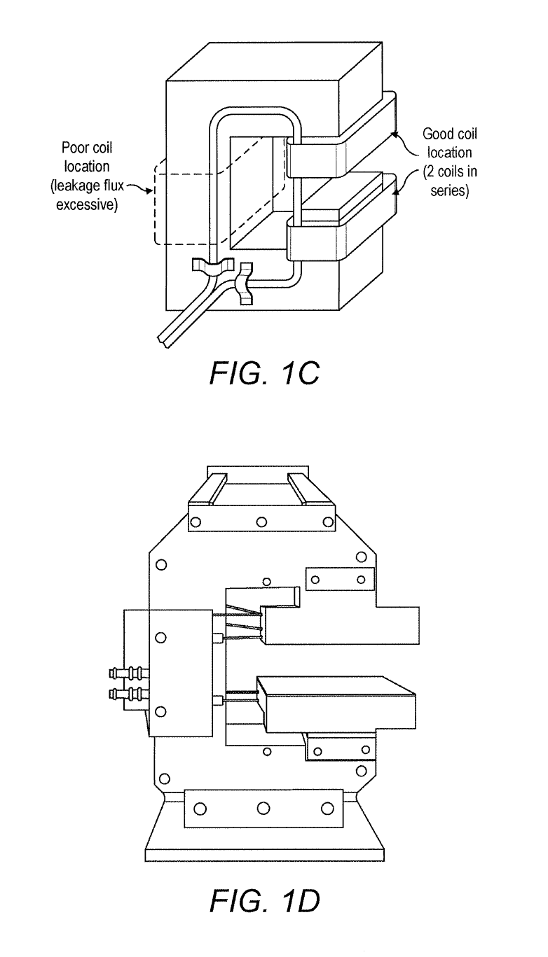

FIG. 1A shows a flowchart for a method of magnetising a substrate according to an embodiment of the present invention;

FIG. 1B shows a simple circuit diagram of a magnetizer used in according to an embodiment of the present invention;

FIG. 10 shows a illustrative perspective view of a “C” magnetizing fixture which may be employed by an embodiment of the present invention;

FIG. 1D shows a photograph of a “C” magnetizing fixture which may be employed by an embodiment of the present invention;

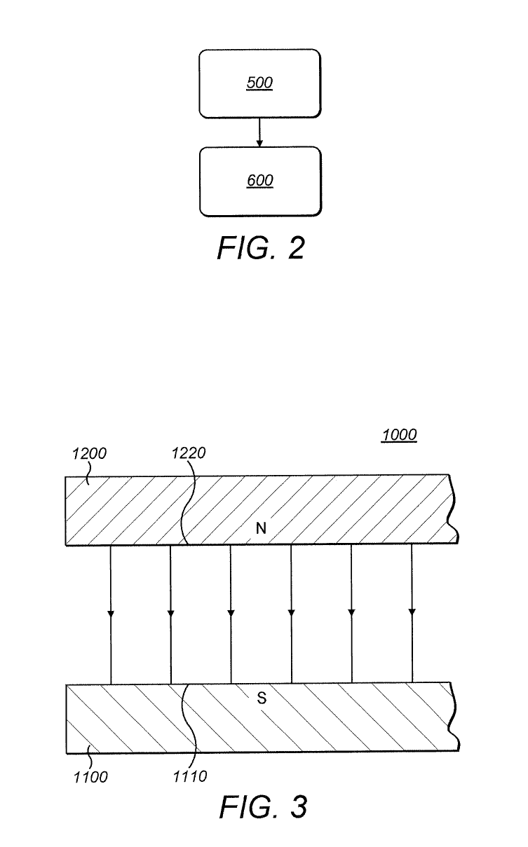

FIG. 2 shows a flowchart for a method of forming a magnetic closure according to an embodiment of the present invention;

FIG. 3 shows a cross-sectional view of a magnetic closure according to an embodiment of the present invention;

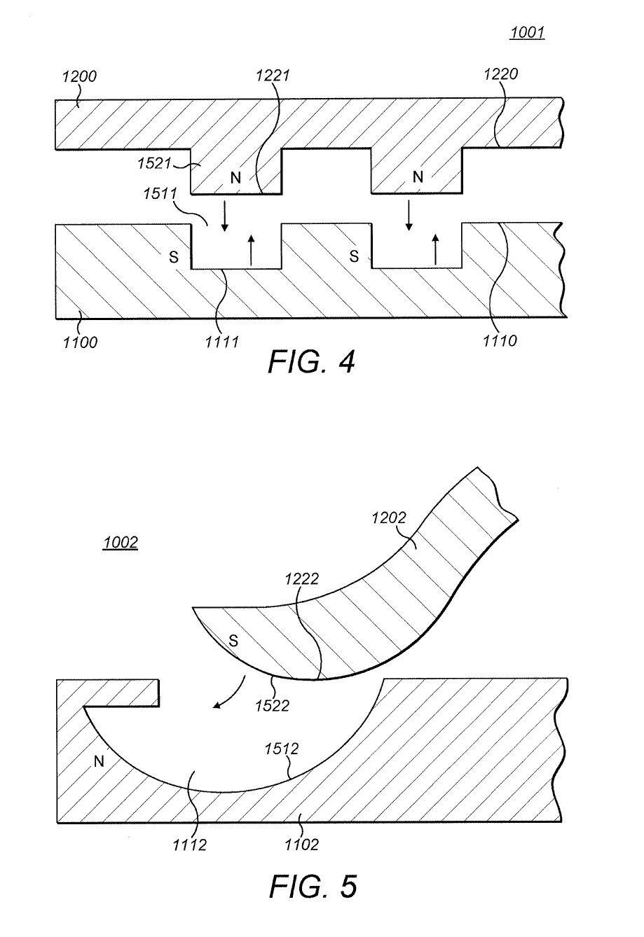

FIG. 4 shows a cross-sectional view of a magnetic closure comprising topographical features according to an embodiment of the present invention;

FIG. 5 shows a cross-sectional view of another magnetic closure comprising topographical features according to an embodiment of the present invention;

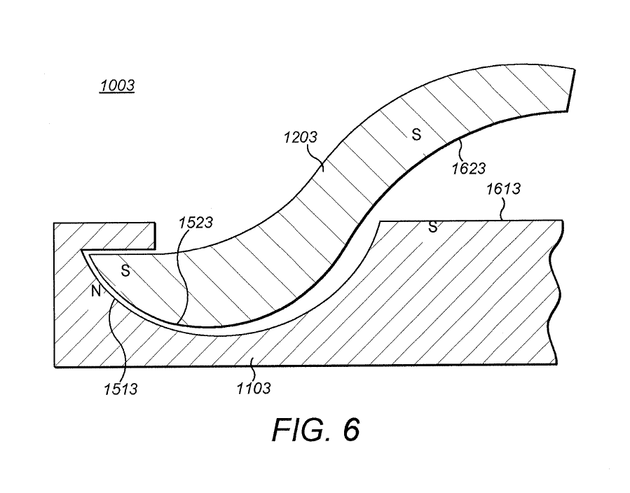

FIG. 6 shows a cross-sectional view of yet another magnetic closure comprising topographical features according to an embodiment of the present invention;

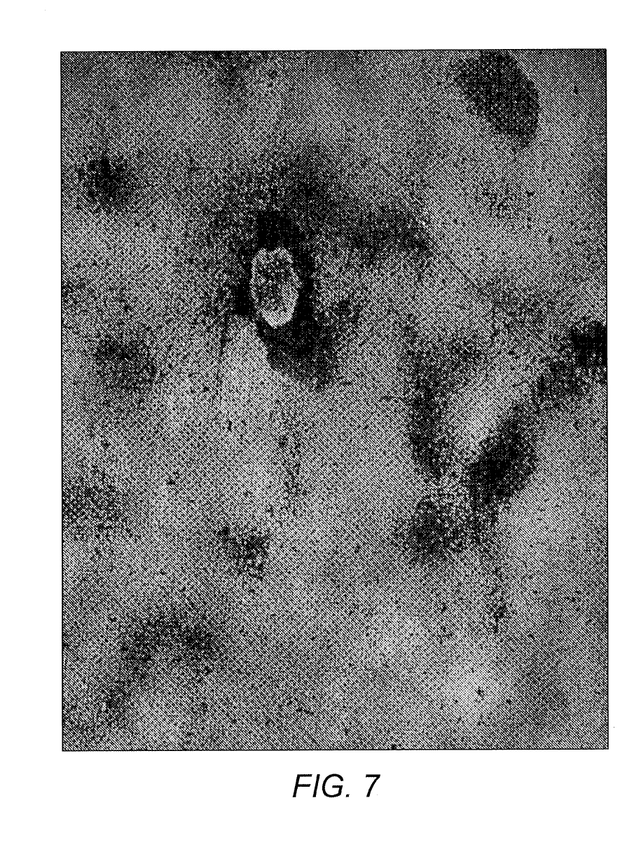

FIG. 7 shows a Scanning Electron Microscope (SEM) image of variations in coating uniformity caused by gravitational settlement and agglomeration of the magnetite particles (Fe₃O₄—12.3 w/v %) in dispersion;

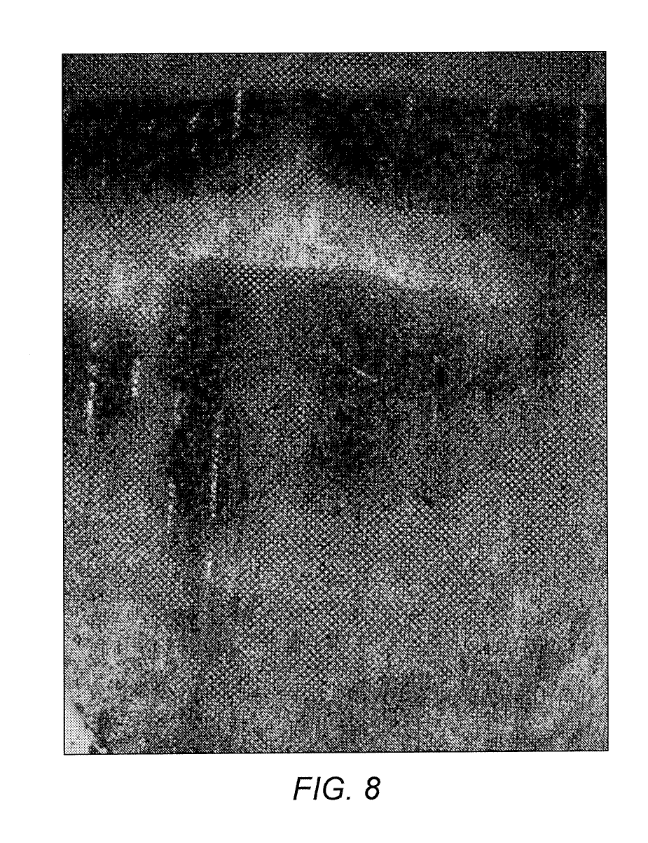

FIG. 8 shows a SEM image of knife coated fabric showing variations in coating thickness due to the coating formulation properties resulting from magnetite (Fe₃O₄—23.2 w/v %);

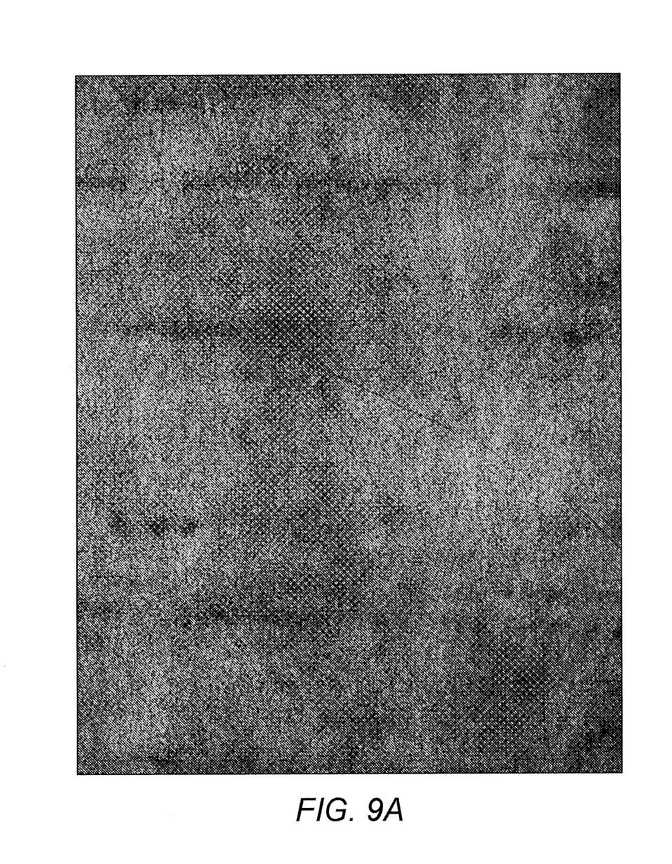

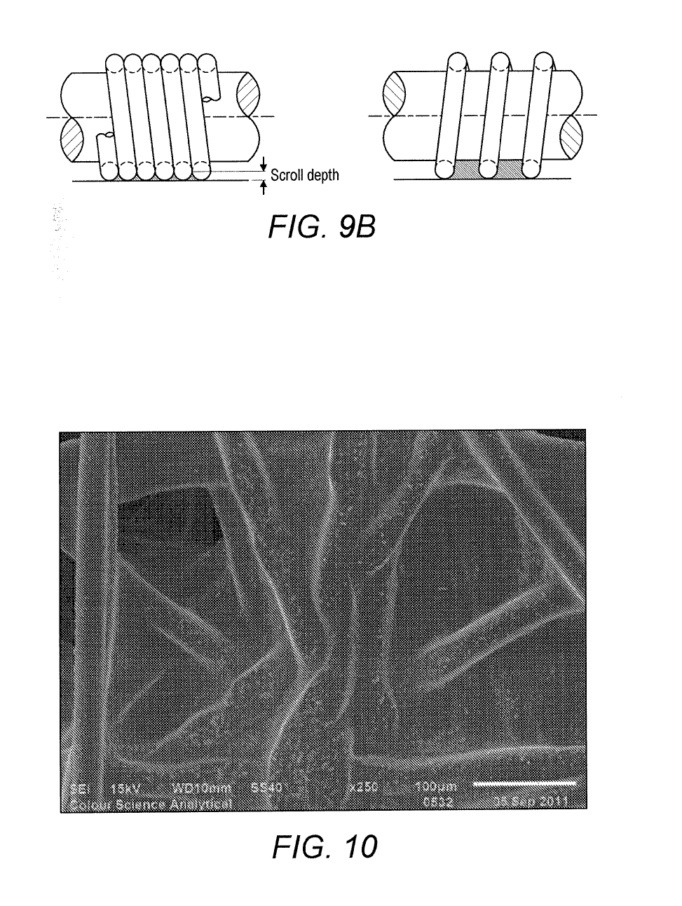

FIG. 9A shows a SEM image of pad-calendered fabric showing relatively uniform distribution of the coating (Fe₃O₄—23.2 w/v %);

FIG. 9B shows a diagram illustrating the scroll depth of a k coater which may be employed by an embodiment of the present invention;

FIG. 10 shows electron myscroscopy analysis of the spread and dispertion of magnetite of varying amounts and concentration. Uniformity is observed through analysis of concentration, distribution and spread per 100 μm of fabric. The figure shows a SEM image of a fabric with 4.5 g of Magnetite in a mass concentration of 12.3 w/v % applied using the film deposition technique with two calendar rollers at pressure (electron myscroscopy analysis of the spread and dispertion of magnetite of varying amounts and concentration and uniformity is observed through analysis of concentration, distribution and spread per 100 μm of fabric);

FIG. 11 shows electron myscroscopy analysis of the spread and dispertion of magnetite of varying amounts and concentration. Uniformity is observed through analysis of concentration, distribution and spread per 100 μm of fabric. The figure shows a SEM image of a fabric with 9.4 g of Magnetite in a mass concentration of 23.2 w/v % applied using the film deposition technique with two calendar rollers at pressure (electron myscroscopy analysis of the spread and dispertion of magnetite of varying amounts and concentration and uniformity is observed through analysis of concentration, distribution and spread per 100 μm of fabric);

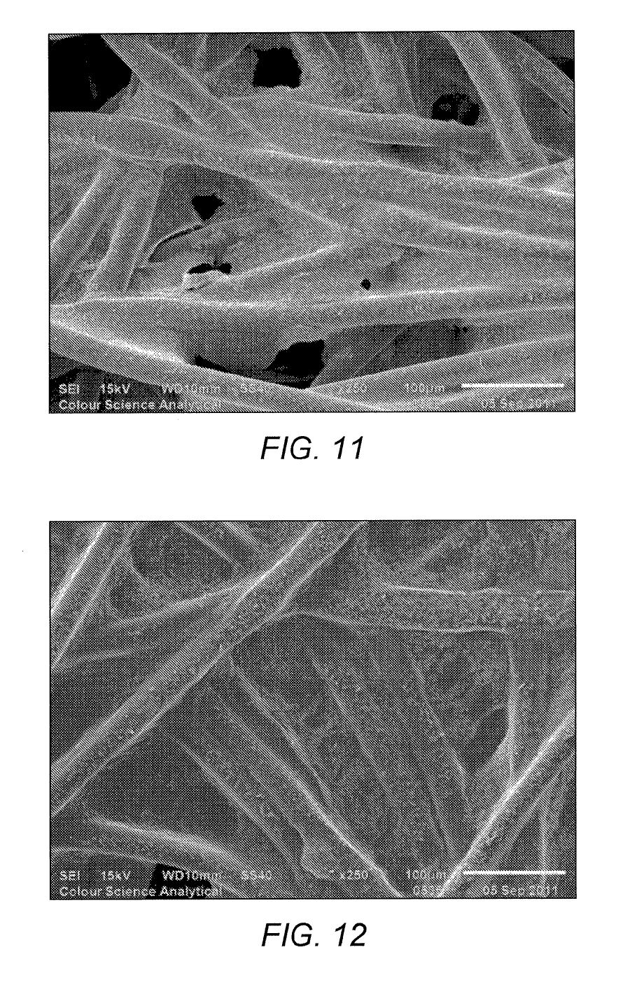

FIG. 12 shows electron myscroscopy analysis of the spread and dispertion of magnetite of varying amounts and concentration. Uniformity is observed through analysis of concentration, distribution and spread per 100 μm of fabric. The figure shows a SEM image of a fabric with 12 g of Magnetite in a mass concentration of 27.3 w/v % applied using the film deposition technique with two calendar rollers at pressure (electron myscroscopy analysis of the spread and dispertion of magnetite of varying amounts and concentration and uniformity is observed through analysis of concentration, distribution and spread per 100 μm of fabric);

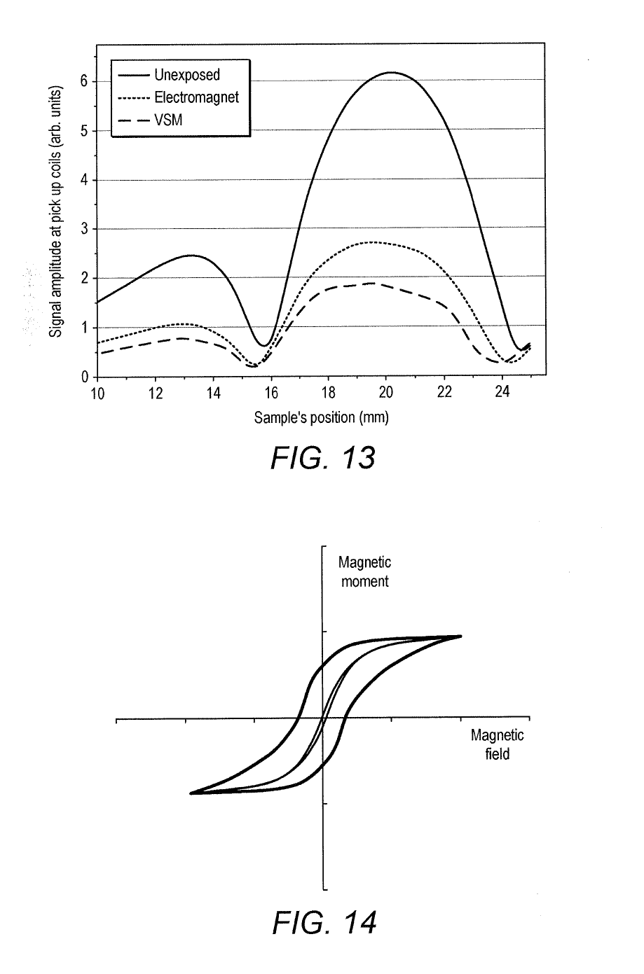

FIG. 13 is a graph showing the pick-up coils signals as samples from the same nonwoven (14 g of Fe₃O₄ binder) are moved up and down in respect to the pickup coils (centre at 19.5-20 mm). The signal is weakest for samples that have not been exposed to magnetic fields, stronger for samples exposed to a magnetic field of approx. 500 mT in the electromagnet, and strongest of all for samples exposed to the same field inside the VSM. The signal has been normalised by the mass of the samples. The generally upper line=VSM, generally middle line=electromagnet and generally lower line=unexpected;

FIG. 14 is a graphical schematic comparison between the hysteresis loops of a soft magnetic material such as magnetite (centre line) and a permanent hard magnet (outlining lines) with the same saturation magnetic moment but much larger coercivity and remnant moment; and

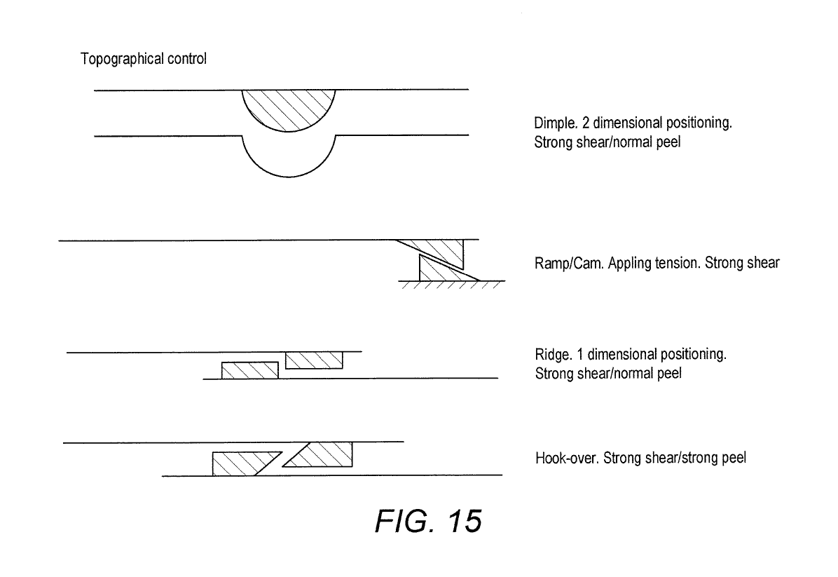

FIG. 15 shows a number of topographic features which could be employed on the surface of a magnetic closure in accordance with certain aspects of the present invention, including: a) dimple; b) ramp/cam; c) ridge; and d) hook-over.

Referring to FIG. 1A, according to an embodiment there is provided a method of magnetising a substrate comprising the steps of: preparing a magnetising coat by dispersing a plurality of particles of at least one magnetisable material in a binder 100; applying the magnetising coat on a surface of the substrate 200; setting the magnetising coat 300; and magnetising the magnetisable material in the magnetising coat by exposing the magnetising coat to a magnetic field 400.

Prior to the step of preparing the magnetising coat, the plurality of particles may be prepared or formed using standard techniques such as abrasion with sandpapers of different grain sizes and/or electrodeposition. Alternatively, the plurality of particles may be obtained as commercially available products.

A plurality of magnetisable material such as magnetic micro and/or nano particles are deposited into, and/or onto, a substrate such as any flexible structure (which may additionally be laminated) and/or a nonwoven fabric, whereby a highly adaptable fastening device, i.e. a magnetic closure, with a fastening force for use with the flexible laminate structure and/or nonwoven fabric is formed. Preferably, the size of the micro and/or nano particles is optimised for achieving the largest overall net magnetic moments whilst still being larger than the size at which the superparamagnetic limit of the particles is reached.

In order to magnetise the substrate, with an aim of also forming a magnetic closure, the magnetic micro-particles are incorporated into the substrate using binder dispersion and the resulting substrate comprising the substrate and the binder/micro-particles is magnetised thereafter.

As the magnetic micro-particles, Magnetite (Fe₃O₄) powders in micro scale were used in the example detailed later. For example, Magnetite micro-particles with diameters of 5 micron or less may be used. Magnetite is a ferromagnetic material and is able to retain at least some of the overall net magnetic moment after being exposed to an external magnetic field.

It is understood that in place of the magnetisable material any other material may be used as long as it is capable of retaining at least some of the overall net magnetic moment after exposure to an external magnetic field, for example any ferromagnetic or ferrimagnetic material. Ideally, the magnetisable material needs the ability of enabling a hysteresis loop as close to a substantially square shape so as to lead to stronger fastening forces. In particular other harder magnetic materials may be used to achieve stronger magnetic fields and/or fastening forces. The magnetisable material may comprise micro- and/or nano-particles of at least one such as Magnetite, Neodymium Iron Boron (Nd₂Fe₁₄B), Samarium cobalt (Sm₂Co₁₅ or SmCo₅), and/or an alloy such Alnico containing aluminium, nickel, iron and cobalt Alnico Al_{0.08}Ni_{0.14}Co_{0.24}Cu_{0.03}Fe_{0.51} has a larger coercive field (of around 70 mT) and a higher remanence and saturated moment than the magnetisation of Magnetite, which can lead to stronger fastening forces.

According to an embodiment, applying the magnetising coat at step 200 comprises using at least one of a droplet deposition technique or a film deposition technique.

It is also understood that the applying the magnetising coat at step 200 and/or the setting the magnetising coat at step 300 can also comprise applying an external magnetic field with the magnetisable material already magnetised. This enables alignment of the magnetic domains and/or grain/or force of the magnetisable material in the magnetising coat during the application and/or setting of the magnetising coat. Further depending on the shape of the magnetisable material, this may also enable orientation of the magnetisable material within the dispersion, i.e. the magnetising coat, to be optimised for magnetic domains for achieving the highest overall net magnetic moments after the magnetising the magnetisable material in the magnetising coat at step 400.

According to an embodiment, the setting the magnetising coat at step 300 comprises at least one of drying and/or curing. For example, the step 300 comprises drying and/or curing the fabric with the magnetising coat applied thereto in a through-air convection oven at 140 degrees Celsius for two minutes.

It is understood that, depending on the binder used for the magnetising coat, any other suitable setting step may be used at step 300. For example, the step 300 can comprise a step of binder curing by oxidation, heat, chemical reaction (addition of a curing agent or catalyst), and/or evaporation of a solvent may be used.

According to an embodiment, the magnetising the magnetisable material at step 400 comprises placing the substrate, and therefore the nonwoven composite comprising the nonwoven material (the fabric) and the binder/micro-particles (the magnetising coat), near an electromagnet and/or a superconducting magnet.

For example, a permanent magnet, an electromagnet and/or a superconducting magnet is used to expose an external magnetising magnetic field to the nonwoven composite comprising the nonwoven material (the fabric) and the binder/micro-particles (the magnetising coat). An exemplary electromagnet may have iron poles with a maximum magnetic field of about 500 mT at its centre. An exemplary superconducting magnet may operate at liquid helium temperatures (−260° C.) to generate magnetic fields of up to 9 T. The magnetisable material is then magnetised by the external magnetic field generated by the permanent magnet, the electromagnet and/or the superconducting magnet. The external magnetic field has a magnetic field strength just above and/or around the saturation magnetic field of the nonwoven composite.

According to an embodiment, the magnetising the magnetisable material at step 400 comprises localised magnetising of the magnetisable material on and/or in only a portion of the surface using a capacitive discharge or pulse magnetiser. A high magnitude short pulse is applied to the capacitive discharge or pulse magnetiser located near the portion of the surface of the substrate, and therefore the nonwoven composite comprising the nonwoven material (the fabric) and the binder/micro-particles (the magnetising coat), whereby the magnetisable material of the magnetising coat in the portion are magnetised locally.

Such magnetizers generally operates on a stored energy capacitor bank, where voltage is stored in a capacitor bank and the stored energy is then discharged through a unidirectional switch (ignition or SCR) into a charging fixture or transformer. The duration and wave shapes depend on the capacity of the bank, the inductance of the fixture and /or transformer and resistance and shape of the fixture. Pulse duration of 100 us to several tens of ms may be obtained. By use of such systems, extremely high current and consequently high fields may be obtained without undue heating. FIG. 1B shows a simple circuit diagram of a magnetizer and FIGS. 1C-1D shows examples of c-shaped fixtures that may be used to provide discrete, localised magnetisation. The air gap would be formed to accommodate the thickness of fabric, and the dimensions of the fixture reduced to match those of the discrete, localised, magnetised area desired.

According to a yet another embodiment, the method of magnetising a substrate further comprises a step of demagnetising the magnetisable material before magnetising the magnetisable material at step 400, and/or after the step of applying the magnetising coat at step 200 or the setting the magnetising coat at step 300 when the step also comprises applying an external magnetic field with the magnetisable material already magnetised. The demagnetising step comprises at least one of: applying a suitably intense magnetic field in a direction opposite to that of the existing magnetization to reduce or destroy that magnetization of the magnetisable material; and/or heating the magnetisable material to a temperature above its Curie point.

It is understood any technique for demagnetising the particular magnetisable material used can be used in the demagnetising step as long as randomisation of the magnetic domains is achieved.

According to a yet another embodiment, the method of magnetising a substrate further comprises a step of altering the magnetic domain orientation of the magnetisable material using the demagnetising step and/or the magnetising step 400. Preferably, the altering comprises switching the magnetic domain orientation and/or magnetic field orientation. Preferably, localised altering and/or switching of the magnetisable material on and/or in only a portion of the surface using a capacitive discharge or pulse magnetiser is achieved using the localised magnetising step described herein.

Referring to FIG. 2, according to an embodiment there is provided a method of forming a magnetic closure comprising a first surface and a second surface, the method comprising the steps of: magnetising a first substrate whereon the first surface is located using the method of magnetising a substrate as described herein 500; and preparing the second surface by providing at least one of paramagnetic material or diamagnetic material thereon, and/or by magnetising a second substrate whereon the second surface is located using the method of magnetising a substrate as described herein 600, wherein the second surface is arranged to engage the first surface using a magnetic field from the magnetised first or second substrate, whereby the magnetic closure closes and/or remains closed. For example, the engagement between the first and second structures cab provide a mechanical coupling so that the magnetic closure remains closed unless an unfastening force of a predetermined magnitude in a specified direction is applied to the magnetic closure.

When the second surface is provided with magnetisable material, the magnetisable material of the second surface is magnetised in an opposite orientation as the magnetisable material of the first surface so that the magnetic field/force exerts a repulsive force between the first and second surfaces. Alternatively, when the second surface is provided with magnetisable material, the magnetisable material of the second surface is magnetised in the same orientation as the magnetisable material of the first surface so that the magnetic field/force exerts an attractive force between the first and second surfaces.

The first and/or second substrate is a nonwoven composite comprising the nonwoven material (the fabric) and the binder/micro-particles (the magnetising coat) as described above. Preferably, the first substrate and the second substrate are the same single substrate, and the first and second surfaces face each other when the substrate, i.e. fabric, is folded.

According to an embodiment, the method of forming a magnetic closure further comprises the steps of: providing a first structure on the first surface; and/or providing a second structure on the second surface, wherein the first and second structures are arranged to be mechanically engaged, whereby predetermined portions of the first surface and the second surface engage to close the magnetic closure and/or maintain the closure thereof.

It is understood that any suitable stamping, patterning and/or embossing technique can be used to provide the first and/or second structure as long as the substrate is a suitably deformable substrate, for example a fabric.

Where the magnetising coat has relative high viscosity to retain a shape during the setting step 300 and the magnetising coat is applied using a roller at step 200, the roller itself comprises a stamp, a pattern and/or an embosser on its surface so that the dried and/or cured magnetising coat (after the setting step 300) retains the stamped, patterned and/or embossed topographical feature as the first and/or second structure. This is particularly advantageous since the applying step 200 also doubles as the first and second structure provision steps. Further, the dried and/or cured magnetising coat can also help the deformable and/or flexible substrate, i.e. fabric, to hold that shape.

It is understood, however, that the roller comprising the stamp, the pattern and/or the embosser may be used on the nonwoven composite comprising the nonwoven material (the fabric) and the binder/micro-particles (the magnetising coat including the magnetisable material) after the setting step 300 to provide the first and/or second structure as well. It is also understood that the first and/or second structures can also be formed by patterning the magnetising coat on the first or second surface using techniques such as stamping, ink-jetting and/or photolithography depending on the binder used in the magnetising coat.

The first and/or second structure comprises at least one of high friction surface, ridges, channels, protrusions, and/or recesses. The first and second structures are reciprocally shaped and/or guide shaped so that the engagement between the first and second surfaces is secure and/or guided in a particular direction and/or orientation.

According to an embodiment, the first and/or second substrate, which is deformable and/or flexible, is provided with a number of topographical structures, for example the first and second structures, and a first portion of the first substrate and a second portion of the second substrate are then be locally magnetised at step 400. This combination of the localised magnetisation and the topographical features (for example, the first and second structures) is particularly advantageous because the localised magnetised first and/or second portions can be magnetised and/or located to encourage and/or discourage the engagement between the reciprocal shape and/or guide shape of the topographical features, i.e. the first and second structures, whereby the fastening action and/or fastening force of the magnetic closure may be encouraged and/or increased, respectively. These advantages are explained in more detail in relation to the magnetic closure embodiment described later in relation to FIGS. 3-6.

Referring to FIG. 3, according to an embodiment of the present invention there is provided a magnetic closure 1000 comprising a first surface 1110 and a second surface 1220, wherein: a first substrate 1100, whereon the first surface 1110 is located, is magnetised by a magnetising coat comprising a plurality of particles of at least one magnetisable material in a binder applied on the first surface 1110; the second surface 1220 is providing with at least one of paramagnetic material or diamagnetic material thereon, and/or a second substrate 1200, whereon the second surface 1220 is located, is magnetised by a magnetising coat comprising a plurality of particles of at least one magnetisable material in a binder applied on the second surface 1220; and the second surface 1220 is arranged to engage the first surface 1110 using a magnetic field (shown as arrowed lines) from the magnetised first or second substrate 1200, 1100, whereby the magnetic closure 1000 closes and/or remains closed.

In this embodiment, although not limited thereto, the first substrate 1100 and the second substrate 1200 are magnetised with magnetic domain orientations therein producing magnetic field lines from the second surface 1220 (North or “N” pole) to the first surface 1110 (South or “S” pole), whereby magnetic attractive force acts between the second and first surfaces 1220, 1110.

The first substrate 1100 and the second substrate 1200 are the same single substrate folded over on a side and the first and second surfaces 1110, 1220 are different portions of a surface of the same substrate locally magnetised in opposite orientations.

Referring to FIG. 4, according to an embodiment of the present invention there is provided a magnetic closure 1001, which is a variation on the magnetic closure 1000 of FIG. 3, further comprising a first structure 1511 provided on the first surface 1110; and a second structure 1521 is provided on the second surface 1220, wherein the first and second structures 1511, 1521 are arranged to be mechanically engaged, whereby predetermined portions 1111, 1221 of the first surface and the second surface engage to close the magnetic closure and/or maintain the closure thereof.

The magnetic closure 1001 shown in FIG. 4 comprises a protrusion as the second structure 1521 on the second surface 1220 of the second substrate 1200 and a recess, reciprocally shaped to receive and mechanically engage the protrusion, as the first structure 1511 on the first surface 1110 of the first substrate 1100.

It is understood that the first and/or second structure can comprise at least one of any of friction surface, ridges, channels, protrusions, and/or recesses for providing mechanical engagement between the first and second substrates 1100, 1200.

Referring to FIG. 5, according to an embodiment of the present invention, there is provided a magnetic closure 1002, which is a variation on the magnetic closures 1000, 1001 of FIGS. 6 and 7, comprising a first substrate 1102 and a second substrate 1202 with a first structure 1112 provided in/on the first substrate 1102.

In the magnetic closure 1002 shown in FIG. 5, the outer contour of the second substrate 1202 itself serves as a second structure 1222, and the first structure 1112 comprises a guide portion 1512 is shaped to guide a portion 1522 of the second substrate 1202 so that as the attractive force from the magnetic field of the magnetised portions/zones (“N” and “S”) of the first and second substrate 1102, 1202 draw the first and second substrates 1102, 1202 together towards a closed state, relative orientation/position/travel path thereof are guided/corrected so that the magnetic closure can be closed with the intended portions of the first and second substrates 1102, 1202 mechanically engaged. This guiding enables the magnetic closure to be mechanically coupled properly, i.e. engage at the intended and/or most effective sites, so that it can remain in the closed configuration/state more easily.

Although the first and second substrates 1102, 1202 can be locally magnetised, it is very difficult to control the relative orientation/position/travel path of the first and second substrates 1102, 1202 as the magnetic closure closes using the magnetic force alone. By providing the first and second structures 1112, 1222, guiding functionality is provided so that the orientation/position/travel path can be better controlled so that the most effective sites/portions of the first and second substrates 1102, 1202 are mechanically engaged when the magnetic closure is closed. This ensures an optimised fastening force is present between the first and the second substrates 1102, 1202.

It is understood that other design and/or topological structure variations may be provided as well to achieve different effects such as separation, i.e. provision of a cavity/space, between the first and second substrates.

Referring to FIG. 6, according to an embodiment of the present invention, there is provided a magnetic closure 1003, which is a variation on the magnetic closures 1000, 1001, 1002 of FIGS. 6, 7 and 8, further comprising a third surface 1613 and a fourth surface 1623 on the first substrate 1103 and the second substrate 1203, respectively. The magnetic closure 1003 shown in FIG. 6 also comprises all the features of the magnetic closure shown in FIG. 5, for example, the first substrate 1102 (1103 in FIG. 6), the second substrate 1202 (1203 in FIG. 6), the guide portion 1512 (1513 in FIG. 6), and the “guided” portion 1522 (1523 in FIG. 6) of the second substrate 1203. The third surface 1613 and the fourth surface 1623 are locally magnetised using the method of magnetising a substrate as described herein with the magnetic domain orientation therein being orientated so that a repulsive force is present between the third surface 1613 and the fourth surface 1623. As the second substrate 1203 is a flexible substrate, for example a fabric, the repulsive force forces the third and fourth surfaces 1613, 1623 to be separated by a cavity/space. This separation provides a tongue for a user of the magnetic closure to hold onto when the magnetic closure 1003 needs to be operated and/or opened by the user. This is advantageous because without this tongue, the third and fourth surfaces 1613, 1623 may be in contact causing some adhesion therebetween, owing to a number of causes such as static electricity, making it very difficult to unfasten/open the magnetic closure.

It is understood that a number of variations on the combination of localised mechanical engagement and/or localised separation is possible to achieve other effects, not just functional effect but also an aesthetic effect. According to an embodiment, the first and/or second substrate, which is deformable and/or flexible, is provided with a number of topographical structures, for example the first and second structures, and a first portion of the first substrate and a second portion of the second substrate are then be locally magnetised at step 400. This combination of the localised magnetisation and the topographical features (for example, the first and second structures) is particularly advantageous because the localised magnetised first and/or second portions can be magnetised and/or located to encourage and/or discourage the engagement between the reciprocal shape and/or guide shape of the topographical features, i.e. the first and second structures, whereby the fastening/unfastening action, and/or fastening force of the magnetic closure can be encouraged and/or increased. This combination enables the present invention to achieve a wide ranging design freedom with the substrate, i.e. fabric, so that diverse functional and/or aesthetic effects can be provided with the operation of the magnetic closure. FIG. 15 shows a number of possible topographical features which could be employed including: a) dimple; b) ramp/cam (; c) ridge; and d) hook-over.

Further, a magnetic closure formed according to embodiment of the present invention has the advantages of repeatability/reproduceability of the closure mechanism, noiseless fastening, durability throughout the lifetime, resistance against external treatment of the fabric using water and/or detergents, relatively smoothness of the fabric, seamless incorporation into the fibres of fabric (before, during and/or after manufacturing options), high closure force, controllably localised fastening properties on the fabric, and the possibility of switching the magnetic orientation remotely.

### EXAMPLE

Small-scale samples were prepared for the evaluation of magnetic properties using pilot-scale processing facilities, and quantitatively analysed to determine efficacy.

All materials were obtained from commercial sources. Magnetite (Fe₃O₄) particles of less than 5 μm diameter were obtained of 95% purity (SIGMA-ALDRICH). A film-forming polymer was selected in to which the Magnetite particles could be dispersed. This was a water based emulsion binder, Vinamul® 3301 (Celanese Emulsions). Vinamul® 3301 is a self-crosslinking copolymer dispersion of vinyl acetate and ethylene that is widely used in industry. A 30 gm⁻² polypropylene (PP) spunbond fabric was selected as a coating substrate. To identify the critical Magnetite (Fe₃O₄) content, seven different coating formulations containing Magnetite were prepared by combining the emulsion binder and Magnetite. The weight concentrations of the Magnetite in the dispersion are provided below in Table 1. Particles of known concentration were mixed with a constant amount of binder aid water. Each coating formulation was thoroughly mixed for 60 seconds to obtain a uniform dispersion of Fe₃O₄ particles.

TABLE 1
Fe₃O₄ (w/v %) with respect to binder and water

| Sample | Fe₃O₄ (w/v %) |
|---|---|
| 1 | 12.3 |
| 2 | 15.8 |
| 3 | 20.0 |
| 4 | 23.2 |
| 5 | 24.5 |
| 6 | 27.3 |
| 7 | 30.4 |

To identify the most suitable method of application, three different techniques were explored as a means to transfer the dispersion to the fabric:

1. Spray gun (droplet deposition).

2. Knife over bed coating (continuous film deposition).

3. Padding by full saturation utilising a calender (impregnation).

Spraying Each coating dispersion was introduced into the spray gun (RECORD METABO FB 2200) container operating with a circular nozzle having a diameter of 1 mm. Spraying was conducted at 4 bar pressure as this was found to permit continuous spraying over the fabric surface. The nozzle to substrate distance was approximately 250 mm. An A4 size (21 cm×28 cm) sample of the PP spunbond fabric sample was mounted on large foam support during spraying to prevent any distortion of the substrate. Owing to gravitational settlement and agglomeration of the Magnetite particles, dispersion variations in the coating uniformity were observed. The particle agglomeration led to particles sometimes being deposited in blocks onto the fabric surface as shown in FIG. 7. Following coating, fabrics were cured in a through-air convection oven at 140° C. for 2 min.

### Knife Coating

To obtain experimental samples a knife over bed K control coater was utilised with adjustable speed controls. A PP spunbond fabric sample was placed on the bed of the coater. A coating rod with a scroll depth of 3 μm was fitted that could adequately generate a continuous film for application to the fabric. The dispersion was introduced in front of the rod and the traverse speed was set to 1.5 m·min⁻¹. It was observed that the Magnetite content directly influences the viscosity and shear properties of the dispersion. The friction between the dispersion and the rod resulted in patches over the fabric as shown in FIG. 8. The fabric was dried and cured in a through-air convection oven at 140° C. for 2 minutes.

Use of the knife over bed control coater enables the viscosity and/or shear properties of the dispersion to be controlled by varying the mass concentration of the Magnetite particles in the magnetising coat. It is noted that, depending on the scroll depth, the frictional force between the dispersion and the coating road can lead to patches of the magnetising coats appearing on the surface.

### Padding

This process employed two sets of calender rollers, one of which could be adjusted to change the nip gauge. The fixed roller was driven by motor and the second roller friction driven by the fixed roller. A pressure of 2 bars was applied between these rollers at a speed of 1 m·min-1. The dispersion was poured over the rollers and the fabric introduced between them. Owing to the pressure applied between the rollers, the dispersion was forced into the fabric resulting in the penetration of Magnetite particles into the pore structure of the fabric. Following padding, samples were dried and cured in a through-air convection oven at 140° C. for 2 minutes. A representative sample of the fabric is shown in FIG. 9A.

The K control coater uses rods with wire of certain diameter wound in a spiral along its length from one end to the other. The depth of the voids between each revolution of wire determines the thickness of coating that can be applied as it pushes the coating fluid reservoir across the substrate. The depth of the voids between each revolution of wire can be referred to as the scroll depth and such scroll depth is illustrated in FIG. 9B.

The nip gauge refers to the pressure applied in a pad mangle to squeeze the rollers together, and therefore forcing the binder/particle fluid into the spun-bond substrate.

It is understood that when any substrate with a porous structure is used, the use of the film deposition technique with two calendar rollers at a pressure will result in such penetration and/or retention of the magnetisable material within the substrate, which is advantageous in achieving higher overall net magnetic moment from the magnetised substrate

### Magnetising

It was then determined if the coated samples could be successfully magnetised in a magnetic field, and, whether the magnetisation remaining in the nonwoven composite material after application and removal of the magnetic field was strong enough to create a permanent magnet which could eventually be suitable for use in a closure system. The magnetic force between two magnetic poles is proportional to the magnetic moment of the samples and this physical quantity was measured.

Magnetic fields were applied to the nonwoven composite via an electromagnet and a superconducting magnet. The electromagnet had iron poles and a maximum magnetic field at its centre of about 500 mT. To achieve the best suited technique for magnetisation square samples (10 cm²) and strips (20×3 cm) were cut from the nonwoven materials. The strip samples were fitted into the space around the poles of the magnet, whereas the square samples were fitted in between the poles. Samples with the higher magnetite concentrations were visibly attracted by the magnetic field.

After magnetisation, two samples (5 mm×5 mm) were cut from the nonwoven sample to analyse the magnetism; one from the centre of the magnetised nonwoven and another control sample of the same nonwoven but from an area unexposed to the magnetic field. The mass of the analysed samples varied between 1 mg for the lower magnetite concentrations and 4.5 mg for the most highly concentrated. These measurements provided a direct comparison between the magnetic moment of the magnetised samples with the unexposed nonwoven.

By measuring the magnetic hysteresis loops the maximum strength of the magnetisation (saturation magnetisation) compared with the remnant or zero-field magnetisation after applying a field can be determined. This measurement provides information of how difficult it is to “erase” the magnetic moment of the sample, i.e. how big a field is required to demagnetise the fabric.

The magnetisation of the nonwoven composite samples were measured using a vibrating sample magnetometer (VSM). This instrument is based on the induction law of Faraday. A sample was vibrated at a frequency of 55 Hz with amplitude of 1.5 mm between a set of coils. The AC magnetic field generated by the oscillating magnetised sample generated an electric voltage in the pickup coils. This voltage was measured through a lock-in amplifier and provides the magnetic moment of the sample. Inside the VSM was a superconducting magnet operating at liquid helium temperature (−269° C.). This magnet is separated from the sample by a vacuum jacket and it allows the measurement of the magnetic moment vs. the external applied field. An electric resistance heater ensured that the temperature of the sample remained at 17° C. The superconducting magnet was able to apply fields of up to 9 T. The saturation magnetic field of the samples was 1 T, and therefore fields no larger than 2 T were applied.

### Analysis

The produced samples were analysed in two ways. Scanning Electron Microscopy (SEM) images were taken to evaluate the dispersion of the magnetite particles. Measurements were taken on the VSM to determine the magnetisation of the samples and to provide a direct comparison between the magnetic moment of the magnetised samples with the unexposed nonwoven. In addition the magnetic hysteresis loops were measured to determine the saturation magnetisation of the samples compared with the remnant or zero-field magnetisation after applying a field.

### Microscopic Analysis of Particle Dispersion

The uniformity of deposition of the Magnetite (Fe₃O₄) particles can be seen in FIGS. 10 to 12. The assessment of uniformity was the relative visual observation between the different application methods trialled. Specifically the improvement in observed uniformity refers to the penetration of the binder and magnetic particles into the interior of the substrate, as opposed to lying on the surface, as was observed with spraying and knife coating. In contrast to the other application methods, the pad-calendared fabric exhibited a more uniform coating distribution, and this has been highlighted in these images. Wth the spraying and knife over bed coating techniques the particles were coated over the fabric surface, whereas in the padding process a greater fraction of the magnetite particles penetrated into the fabric interior. The spray and knife coating methods worked well with less viscous solutions, mainly to avoid friction and choking, which resulted in higher binder to particle ratios.

### Magnetic Strength Analysis

A magnetic signal was measured in all the nonwoven composite samples, including those with the smallest Magnetite concentrations. All samples showed a remnant magnetisation after a magnetic field being applied, and, the initial magnetic moment of the samples previously placed in the electromagnet was higher than that of the unexposed samples. The magnetic moment of the samples after a field being applied and removed inside the VSM was significantly higher than that of the samples where the field had been applied in the electromagnet.

FIG. 13 shows the electric signal in the pickup coils as the samples were moved up and down. The peak in this graph is proportional to the magnetic moment of the sample. The fact that the signal is stronger for samples that have been exposed to fields of 500 mT inside the VSM than for samples exposed to a similar field in the electromagnet points is due to a reduction of the magnetisation during the processing of the sample. A very weak attraction could be observed in samples with high concentrations of Magnetite (≥Fe₃O₄ (23.2 w/v %) 14 g/binder) previously exposed to magnetic fields.

The reason for the smaller magnetic moment in samples exposed to magnetic fields in the electromagnet compared to samples exposed directly inside the VSM could be found in the relatively small coercive fields needed to erase the remnant moment (see FIG. 14 which shows a schematic comparison between the hysteresis loops of a soft magnetic material such as magnetite (central line) and a permanent hard magnet (outlining lines) with the same saturation magnetic moment but much larger coercivity and remnant moment). An ideal permanent magnet would have a square hysteresis loop with large coercive field and the same saturation and remnant moments. For the sample with the higher magnetite concentration the coercive field was just 8.5 mT. External fields from the scissors used to cut the sample, or from remnant fields around the electromagnet used to magnetise the sample could cause this significant reduction in magnetisation. The samples exposed inside the VSM do not undergo any processing, and they are shielded from any external magnetic field, so the magnetic moment is not reduced from its remnant value.

The saturation magnetisation of the nonwoven samples was fairly weak compared to that of bulk Magnetite, even for the most densely covered binder. Magnetite has a magnetic moment per unit mass of 80 A·m2·kg-1. Even though the mass of these samples is too small to determine accurately, and the demagnetisation factor was unverified, the moment per unit mass in the nonwoven textile is one order of magnitude smaller.

### Results

The nonwoven samples showed hysteresis loops and magnetic moment typical of ferrimagnetic materials such as Magnetite. However, these nonwoven samples have a remnant magnetisation and coercive fields that are too small at present to achieve the desired effect of attraction between two strips for commercial purposes. The attraction between two magnets was proportional to their magnetic moments. Given that the remnant moment of the nonwoven samples is 8% of the saturated value, the strength of the magnetic force between two samples is just (0.08)²≈156 times weaker than when the samples are under a magnetic field. The strength of the magnetic force cannot be increased by using particles of smaller size, since this would only decrease the coercive field and may bring the material below the superparamagnetic limit which is when the particles become single magnetic domains with nil or almost nil coercivity above a blocking temperature (300 K for 50 nm particles).

To improve the strength of the magnetic force, different, harder magnetic materials are recommended. The measured Magnetite nanoparticles, as it is the case with other simple compounds and elements such as permalloy (nickel-iron alloy), are a soft magnetic material. It is believed that a permanent magnet with a more square-shaped hysteresis loop would be more efficient. It is also believed that remnant magnetisation of up to 80% could be easily achieved with alternative materials and this would result in attraction between the samples being 100 times stronger, even if the saturation magnetisation was the same.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of magnetising a substantially planar substrate comprising the steps of:
(a) preparing a magnetisable coating by dispersing a plurality of particles of at least one magnetisable material in a binder, where the particles have a diameter of up to 20 μm;
(b) applying the magnetisable coating on a surface of the substrate by droplet deposition and/or film deposition; and
(c) magnetising the magnetisable coating by exposing it to a magnetic field.

2. (canceled)

3. The method of claim 1, wherein the particles have a diameter of up to 5 μm.

4. (canceled)

5. The method of claim 1, wherein the process further comprises setting the magnetisable coating after it has been applied on the surface of the substrate.

6. (canceled)

7. The method of claim 1, wherein droplet deposition comprises spraying the magnetisable coating onto the surface at a predetermined pressure.

8. The method of claim 1, wherein film deposition comprises: placing the substrate on a bed; introducing the magnetisable coating on to a coating rod for generating a continuous film; and introducing the magnetisable coat onto the surface of the substrate by engaging the coating rod onto the surface.

9. The method of claim 1, wherein the film deposition technique comprises: urging the magnetisable coating on to a surface of the substrate by passing the substrate and magnetisable coating through calender rollers under a predetermined pressure.

10. The method of claim 9, wherein the magnetisable coating is applied to the surface of the substrate before or during its passage through the calender rollers.

11. The method of claim 10, wherein the magnetisable coating is poured on to at least one or more of the calender rollers before the substrate is passed therebetween.

12. The method of claim 1, wherein setting the magnetisable coating comprises drying and/or curing.

13-20. (canceled)

21. A magnetic closure comprising a first surface and a second surface, wherein:
a first substantially planar substrate, whereon the first surface is located, is magnetised by a magnetisable coating comprising a plurality of particles of at least one magnetisable material in a binder applied on the first surface;
the second substantially planar surface is provided with at least one of paramagnetic material or diamagnetic material thereon, and/or a second substrate, whereon the second surface is located, is magnetised by a magnetisable coating comprising a plurality of particles of at least one magnetisable material in a binder applied on the second surface; and
the second surface being arranged to engage the first surface using a magnetic field from the magnetised first or second substrate,
where the magnetisable coating is formed by droplet deposition and/or film deposition and the particles in the magnetisable coating have a diameter of up to 20 μm and whereby the magnetic closure closes and/or remains closed when the first and second surfaces are brought in close or adjacent proximity with one another.

22. (canceled)

23. The magnetic closure of claim 21, wherein the particles have a diameter of up to 5 μm.

24. (canceled)

25. The magnetic closure of claim 21, wherein the first substrate and the second substrate are located on different portions of the same substrate and/or are formed in a unitary manner.

26. The magnetic closure of claim 21, wherein:
a first topographical structure is provided on the first surface;
a second topographical structure is provided on the second surface; and
the first and second structures are arranged to be mechanically engagable with one another,
whereby predetermined portions of the first surface and the second surface are mechanically engagable in addition to being magnetically attracted to one.

27. The magnetic closure of claim 26, wherein the first and/or second topographical structures comprises at least one selected from: ridges, channels, protrusions, and/or recesses.

28. The magnetic closure of claim 21, wherein the second surface is provided with magnetisable material which is magnetised in the same orientation to the magnetisable material of the first surface so that the first and second surfaces experience an attractive force from the magnetic field therebetween.

29. The magnetic closure of claim 21, wherein the second surface is provided with magnetisable material which is magnetised in an opposite orientation to the magnetisable material of the first surface so that the first and second surfaces experience a repulsive force from the magnetic field therebetween.

30. The magnetic closure of claim 21, wherein the magnetisable material comprises a ferromagnetic or ferrimagnetic material, said ferromagnetic or ferrimagnetic material being selected from at least one of Magnetite, Neodymium Iron Boron, Samarium Cobalt, or Alnico.

31. (canceled)

32. The magnetic closure of claim 21, wherein the binder is a film-forming polymer.

33. The magnetic closure of claim 32, wherein the binder comprises a water based emulsion binder.

34. (canceled)

35. The magnetic closure of claim 21, wherein the substrate is a nonwoven fabric.

36. (canceled)

37. (canceled)
